(19) United States
(12) Patent Application Publication
(10) Pub. No.: US 2026/0162105 A1
(43) Pub. Date: Jun. 11, 2026

(54) PRIVACY-PRESERVING AUTHENTICATION SYSTEM

(71) Applicant: Via Science, Inc., Somerville, MA (US)

(72) Inventors: Jesús Alejandro Cárdenes Cabré, Montreal (CA); Jeremy Taylor, Montreal (CA); Madjid Aoudia, Rennes (FR); Andrew Musgrave, Vancouver (CA); Tim James Tonelli, Watertown, MA (US)

(21) Appl. No.: 19/180,332

(22) Filed: Apr. 16, 2025

Related U.S. Application Data
(60) Provisional application No. 63/636,551, filed on Apr. 19, 2024.

(51) Int. Cl. G06Q 20/38; G06Q 20/32; G06Q 20/36

(52) U.S. Cl. CPC G06Q 20/3829; G06Q 20/3276; G06Q 20/3674; G06Q 20/3825

(57) ABSTRACT

A system may be configured to provide privacy-preserving authentication for access to a protected resource or service. A user may register to obtain credentials from a trusted issuer for accessing a resource system. To access the resource system, the user may provide a zero-knowledge proof of possession of the credentials. A verifier system may verify that the zero-knowledge proof demonstrates possession of the credentials and that the credentials have not expired. Once verified, the system may initiate a session and create a token that may allow the user to return to the session later without repeating the authentication process and without identifying themselves uniquely.

### CROSS-REFERENCE TO RELATED APPLICATION

This application claims the benefit of priority of U.S. Provisional Patent Application No. 63/636,551, filed Apr. 19, 2024, and entitled “USER AUTHENTICATION USING VERIFIED CREDENTIALS AND ZERO-KNOWLEDGE PROOFS,” the content of which is incorporated herein by reference in its entirety.

### BRIEF DESCRIPTION OF DRAWINGS

For a more complete understanding of the present disclosure, reference is now made to the following description taken in conjunction with the accompanying drawings.

FIG. 1 is a conceptual diagram illustrating a privacy-preserving authentication system for accessing a protected resource or service, according to embodiments of the present disclosure.

FIG. 2 is a conceptual diagram of an example environment in which a user may register with the system to access the protected resource or service, according to embodiments of the present disclosure.

FIG. 3 is a signal flow diagram illustrating example operations of registering with the system, according to embodiments of the present disclosure.

FIG. 4 is a conceptual diagram of an example environment in which the system authenticates a request to access the protected resource or service, according to embodiments of the present disclosure.

FIGS. 5A and 5B are signal flow diagrams illustrating example operations of authenticating a request to access the protected resource or service, according to embodiments of the present disclosure.

FIG. 6 is a block diagram illustrating an example client device and system component communicating over a computer network, according to embodiments of the present disclosure.

### DETAILED DESCRIPTION

The systems and methods described herein relate to authenticating a user to allow access to a resource system while preserving the user's privacy. Traditional user authentication systems may rely on passwords, biometrics, or hardware tokens to verify a user's identity. These manners of authentication have several drawbacks. For example, passwords may be compromised, biometrics may require specialized hardware (as well as potentially implicate privacy concerns), and both may involve uniquely identifying users who access the system. Furthermore, such systems may not provide a seamless user experience across different platforms.

Offered herein are systems and methods for privacy-preserving authentication of users accessing a protected resource or service. The system may use decentralized identity (DID) technology and zero-knowledge proofs (ZKPs) to allow a user to demonstrate possession of digital credentials obtained from a trusted issuer. The user may selectively disclose the digital credentials to prove their identity or attributes without revealing their identity or unnecessary personal information. In this way the user may establish themselves as verified but anonymous for purposes of accessing a resource.

The system may present a user-friendly interface that can output code that can contain (or can direct a device to) information for registering with the system and obtaining authentication to access a protected resource or service. A digital wallet application running on the client device may store digital credentials as well as passwords and/or other information associated with the credentials. To demonstrate possessions of a credential without revealing the actual credential or password, the digital wallet application may generate a verifiable presentation (VP) using secret information obtained from a trusted issuer, a quantum-resistant cryptographic algorithm, and/or a ZKP. For example, in some implementations, the credentials may include a salted hash of a password and/or other secret information. The digital wallet application may regenerate the salted hash using the known password and provide knowledge of the hash without revealing the actual password or salt values. In some implementations, the digital wallet may create a cryptographic key pair and send a key to the trusted issuer for signing a hash of the secret information (e.g., a password or other sensitive data).

A verifier service may validate the VP against the trusted issuer's public keys (e.g., obtained from a decentralized identity registry). Upon verification of the VP, the verifier service may authorize access to the requested resource. In some implementations, the system may create a delegated authentication token and send it to the resource. The token may allow the resource to authorize and track the user's access to the resource for a period of time. In some cases, the token may include a public anonymous identifier generated by the digital wallet application and/or assigned to the user by the system. The token and anonymous identifier may allow the user to revisit the resource and continue a previous session without repeating the authentication process and without uniquely identifying themselves.

In this manner, the system may leverage the benefits of DID technology and ZKP to provide a secure and privacy-preserving method for user authentication. On the client side, a user may selectively disclose credentials to access a resource without revealing sensitive personal information. On the resource side, a service provider may be assured of the user's authenticity and/or attributes without receiving passwords or other personal data.

Various use cases of the described system are possible. These features may be used alone or in combination with each other and/or other features described herein. Various operations of the systems and devices may be subject to user approval. The system may be implemented in a manner that ensures compliance with applicable laws, regulations, standards, etc., in the region(s) where the user, devices, and/or systems are located.

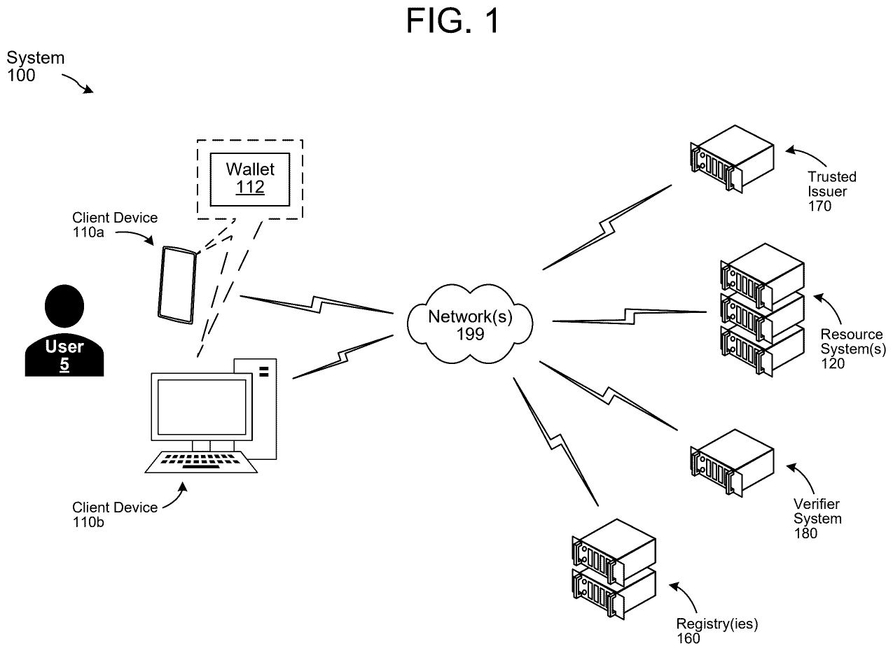

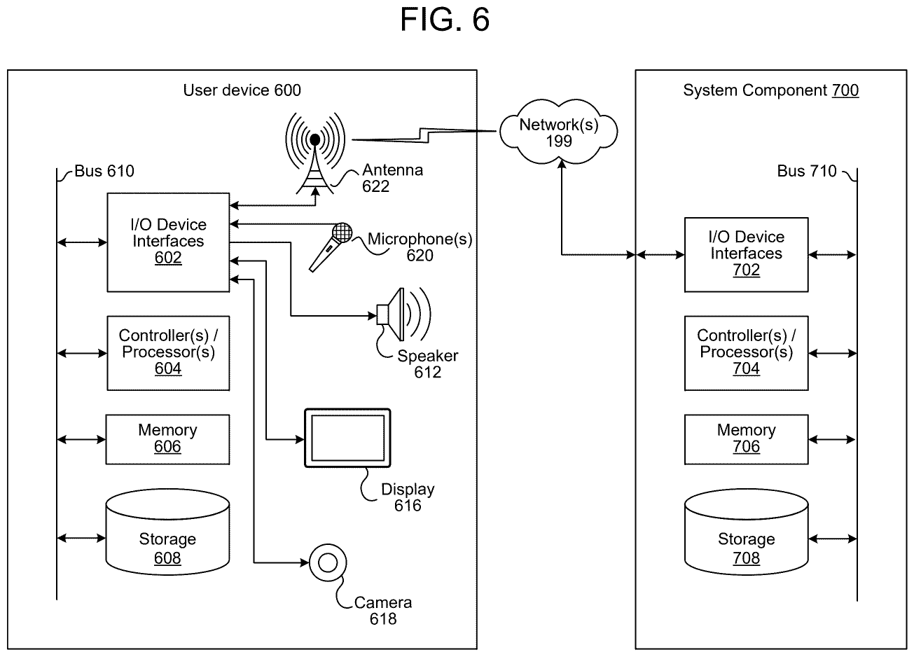

FIG. 1 is a conceptual diagram illustrating a privacy-preserving authentication system 100, according to embodiments of the present disclosure. The system 100 can control user access to a protected resource and/or service. The protected resource/service may be hosted by one or more resource system(s) 120. The system 100 may include one or more client devices 110a, 110b, etc. A client device 110 may be a personal user device such as a mobile phone, tablet or laptop computer, or the like. For example, the client device 110 may include hardware components such as those corresponding to the user device 600 illustrated in FIG. 6. The first client device 110a may be a personal device such as a mobile phone that the user 5 may use to register with the system 100 and authenticate a request for access to the protected resource. The second client device 110b may be a laptop or desktop computer that the user 5 may use to view the visualized data following successful registration and authentication. In some implementations, however, the user 5 may register, authenticate, and/or access the protected resource using a single client device 110.

The client device may have a digital wallet application 112 (“wallet 112”) that can store credentials obtained during registration phase and generate ZKPs during an authentication phase. In some implementations, the user 5 may use the second client device 110b to initiate the registration process and the first client device 110a to complete the registration process. In some implementations, the user 5 may use the second client device 110b to initiate the authentication process and the first client device 110a to complete the authentication process. In some implementations, the user 5 may use the second client device 110b to, following authentication, view data from the protected resource. In some implementations, however, the user 5 may use a single client device 110 to perform all client-side registration operations, all client side authentication operations, and/or all client-side operations for accessing the protected resource. A user 5 may use the client device(s) 110 to access a resource hosted by a resource system 120. The resource system 120 may itself be made up of several systems, and thus may be referred to as the resource system(s) 120. For example, one of the resource systems may host a website into which the user 5 may log in, another resource system may act as a front end with which the user 5 may interact to access resources, yet another resource system may be a back end that hosts the protected resources, applications, and/or services (e.g., for secure data storage and/or processing). To access the resources, the user 5 may register with the system 100 to obtain one or more verified credentials (VCs) from a trusted issuer 170 such as a certificate authority, identity provider, etc. To preserve the user's privacy, the wallet 112 may use digitally signed secret information and/or generate a ZKP to prove possession of the VCs without sharing the identity of the user 5 or the VCs themselves. A verifier system 180 may verify the ZKP in a request for authentication and verify that the VCs are still valid. The system 100 may include one or more registries 160 that maintain information about the user 5, the trusted issuer 170, and/or the VCs. In various implementations, the system 100 may have more, fewer, or different components; for example, certain functions may be combined into one component/system or divided among two or more components/systems. The various components/systems of the system 100 may include and/or execute on one or more system components 700, which may communicate over one or more computer networks 199, as described in further detail below with reference to FIG. 6.

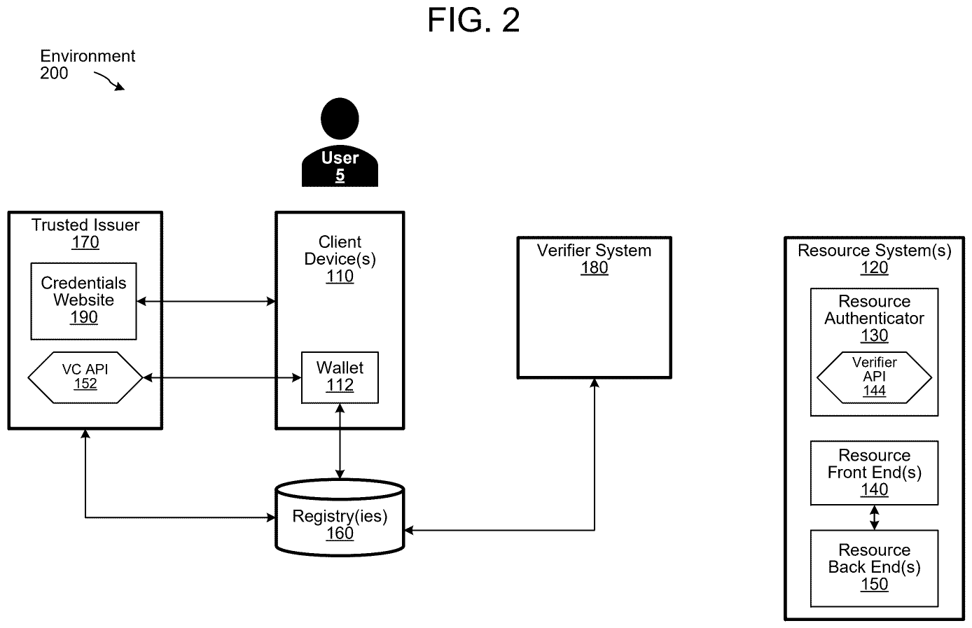

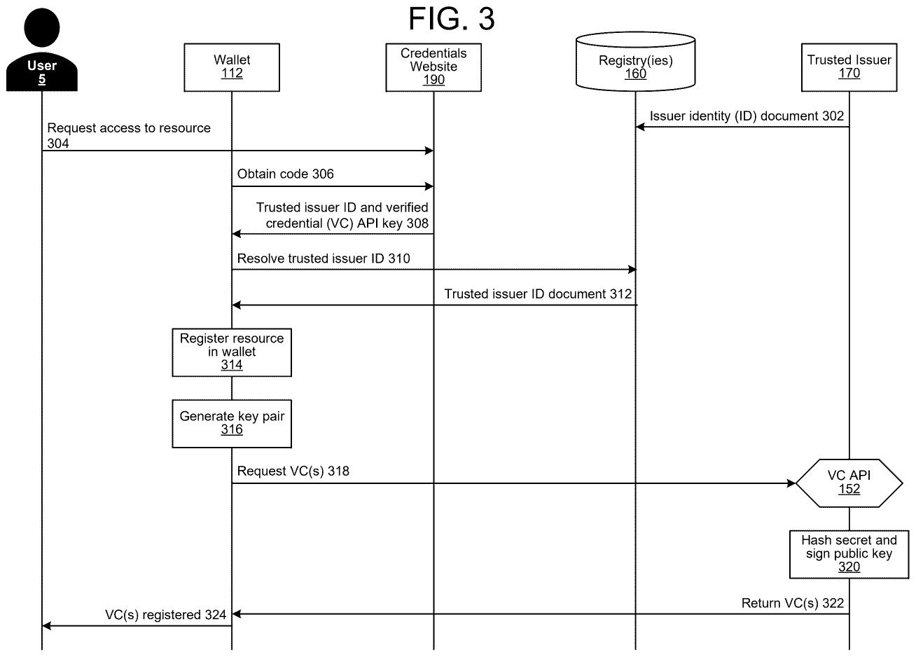

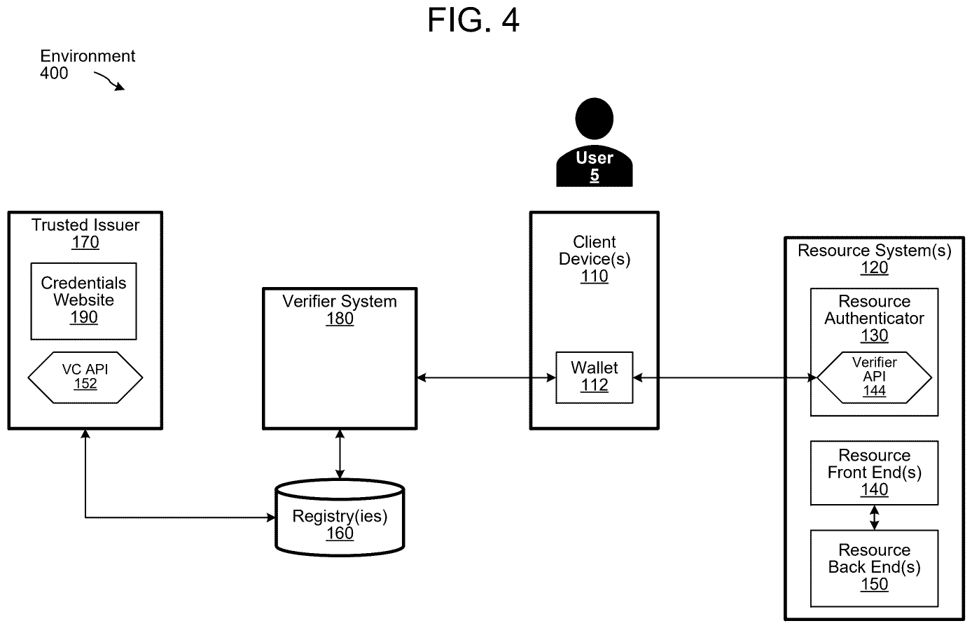

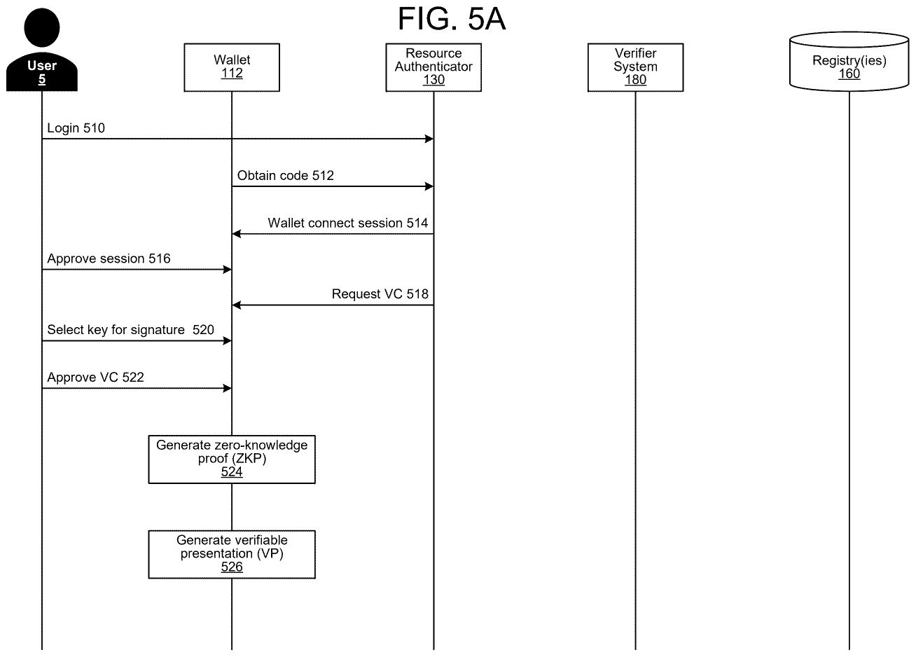

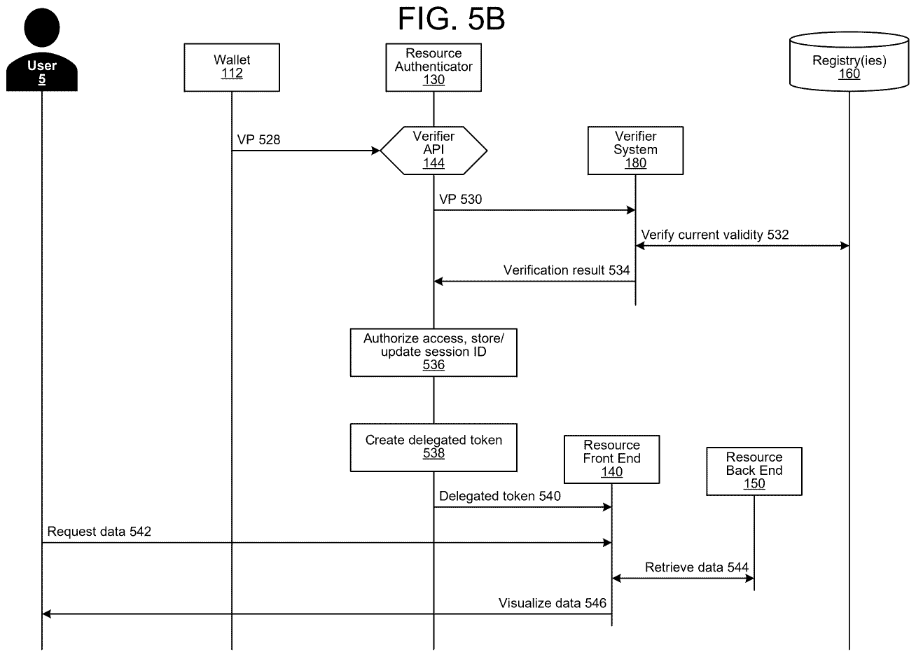

The system 100 may provide for the user 5 to login to the resource system(s) 120 anonymously by demonstrating that they are the expected holder of valid digital credentials. The system 100 may operate in a registration phase (e.g., as illustrated in FIGS. 2 and 3) and an authentication phase (e.g., as illustrated in FIGS. 4, 5A, and 5B). In the registration phase, the user 5 may interact with the resource system(s) 120 to obtain VCs based on an identity document (e.g., a decentralized identity document) from the trusted issuer 170. In the authentication phase, the resource system(s) 120 and/or the verifier system 180 may verify the user's proof of possession of the VCs. Upon verification, the resource system(s) 120 may grant the user 5 access to the requested resource and create a delegated token for tracking the authentication across a session between the user 5 and the resource system(s) 120. The user 5 may then upload data to, execute operations in, and/or download data from the resource system(s) 120 without divulging their identity (although they may present proof of other attributes such as membership of a particular organization, etc.). This type of verified but anonymous access may be appropriate in cases where the resource system(s) 120 can set constraints on computational resources such as processor, memory, storage, and/or network storage.

FIG. 2 is a conceptual diagram of an example environment 200 in which a user 5 may register with a privacy-preserving authentication system 100 to access the resource system(s) 120, according to embodiments of the present disclosure. The user 5 may register with the system 100 to obtain VCs for use in requesting authentication by the system 100 to access a protected resource or service. Following a successful authentication, the system 100 may generate a token that will grant the user 5 access to the resource without the user 5 having to identify her or himself, and without having to repeat the authentication process for subsequent requests to access the resource, prior to expiration of the VCs or token.

The client device 110 may include a digital wallet application 112 (wallet 112), which the user 5 may use to initiate registration. The wallet 112 may store data and execute operations to facilitate the privacy-preserving authentication process to access the resource system(s) 120. The wallet 112 may leverage a camera, antenna, and/or other input device of the client device 110 to capture a code presented by the resource system(s) 120 for purposes of registering and authenticating the client device. For example, the user 5 may attempt to log in to the resource system(s) 120 using the second client device 110b. The resource system(s) 120 may present a quick response (QR) code or other image and/or text characters, etc., on a display of the second client device 110b. The code may represent, for example, a uniform resource locator (URL). The URL may convey information for registering the client device and/or direct the client device to an endpoint where it may retrieve the information. In some cases, the URL or other code may include a session identifier and/or an open attribute, which the resource system(s) 120 can set based on the particular resource (e.g., data and/or application) the user 5 requests access to. In some implementations, the code may be in some other structured and/or unstructured format. For example, a python dictionary object, a JavaScript Object Notation (JSON) file, etc. The user 5 may scan the code, using the first client device 110a (e.g., using the wallet 112). In another example, the code may be conveyed as a string of characters that the first client device 110a may capture and recognize (e.g., using optical character recognition). In yet another example, the code may be presented by wireless means such as Bluetooth, Bluetooth Low Energy, near-field communication (NFC), radio frequency (RF) identification tag, etc., that may be received/read by an antenna of the client device 110. In some implementations, the code may represent information such as identifier's and/or keys for interacting with the system. In some implementations, the user 5 may initiate registration using a single client device 110 by, for example, using the code displayed on that device. For example, if the client device 110 is displaying a QR code, an application of the device (e.g., the wallet 112) may recognizing QR code and navigate to the encoded URL. Similarly, if the client device 110 is displaying some other image data, an app on the device may recognize the image and/or any characters represented in the image, and the user 5 may enter them into the wallet 112. In another example, if the client device 110 is displaying a string of characters (e.g., a URL, JSON, etc.), the user 5 may copy the string and paste it into the wallet 112.

The user may log in to a credentials website 190 to obtain VCs. In some implementations, the credentials website 190 may be hosted by the trusted issuer 170, allowing the user 5 to request the VCs directly. In other implementations, the credentials website 190 may be hosted by a third party. If the credentials website 190 is hosted by a third party, the user 5 may obtain a code that provides the wallet 112 with the identity of the trusted issuer 170 and an application programming interface (API) key for accessing the trusted issuer 170. For example, the VC API key may be a credential for communication with the trusted issuer 170 and/or for verifying the identity of the trusted issuer 170. The wallet 112 may use the trusted issuer identifier to retrieve the trusted issuer's identity document (e.g., a DID document) from the one or more registries 160. A DID is a type of identifier that may be globally unique such that it may enable an entity to be identified in a verifiable manner. The DID may be persistent and may not require the use of a centralized registry. The DID may point to (e.g., “resolve”) a DID document, which may include information describing the entity. The information may include public cryptographic keys, specify endpoints (e.g., for APIs), etc. The identity document may may define an endpoint of the VC API 152, the trusted issuer's public key(s), and, in some cases, an expected renewal frequency of credentials (e.g., one week, one month, six months, one year, etc.). The wallet 112 may send a request for verified credentials (VCs) to the VC API 152 (e.g., hosted by the trusted issuer 170). In some cases, the wallet 112 may use the VC API key to sign the request, allowing the trusted issuer 170 may verify the request. Upon verification, the trusted issuer 170 may return the VCs to the wallet 112.

In some implementations, the system 100 may provide for an added layer of anonymity of the user 5. For example, the wallet may generate a cryptographic key pair and send the public key to the trusted issuer 170. The trusted issuer 170 may hash the user's secret information and/or VCs (in some cases adding a salt value), sign the user's public key using the private key corresponding to a public key in the trusted issuer identity document, and return them to the wallet 112. The wallet 112 may store the VCs for later use to access the resource system(s) 120.

In some implementations, the wallet 112 may calculate a ZKP and/or verifiable presentations of the VCs to gain access to the resource system(s) 120. In some implementations, however, the client device 110 may have limited computational resources for calculating a ZKP; thus, the wallet 112 may leverage another trusted device to calculate the ZKP, which the client device 110 may store the VCs and provide them to the resource system(s) 120 subject to the user's approval.

A zero-knowledge proof allows a party to prove a claim without revealing any additional information. For example, a “prover” can share a proof of the claim with a “verifier” who can verify the accuracy of the proof. A zero-knowledge proof may not prove the claim with certainty, but the acts of proving and verifying may be repeated until the prover demonstrates to the verifier (and, in some case, an external observer or observers) a sufficiently high statistical likelihood that the claim is true, rather than a series of lucky guesses.

A zero-knowledge proof of a claim may satisfy three properties: completeness, soundness, and zero-knowledge. Completeness means that if the claim is true, an honest prover can convince an honest verifier of the claim. Soundness means that if the claim is false, no cheating prover can convince an honest verifier of the claim (e.g., except for some very small probability, which may be reduced by further iterations of proof). Zero-knowledge means that if the claim is true, no verifier (or observer) will learn anything other than the fact that the claim is true.

A zero-knowledge proof may be interactive or non-interactive. An interactive proof system may involve a repeated exchange of messages between the prover (e.g., the client device 110) and the verifier (e.g., the resource system(s) 120 and/or the verifier system 180). In an interactive proof system, it may be assumed that the client device 110 has access to abundant computational resources but cannot be trusted. In contrast, the verifier system 180 may be assumed to be trustworthy but have limited computational resources. The interactive proof system may also involve an ability of the verifier system 180 to make random choices. Through an exchange of messages, the client device 110 may establish a near-certain likelihood that its claim is true, without divulging any information beyond the fact of the truth of the claim. For example, the verifier system 180 may determine that receiving N consecutive verifiable proofs from a client device 110 makes the probability that the client device 110 is asserting a false claim exceedingly low. The resource system(s) 120 and/or the verifier system 180 may select a value of N and/or a threshold confidence score (e.g., corresponding to a likelihood that the client device 110 possesses the credentials it asserts) based on, for example, the potential harm of a bad actor accessing the resource system(s) 120 and/or the sensitivity of the data stored therein. An example of a zero-knowledge protocol that may be used to perform an interactive zero-knowledge proof is a zero-knowledge Scalable Transparent Argument of Knowledge (zk-STARK); however, some versions of zk-STARK may operate non-interactively.

A non-interactive zero-knowledge proof may offer advantages over interactive proofs. For example, a non-interactive proof may be used when the prover and verifier cannot interact (e.g., communicate in real time). Thus, non-interactive proofs may be useful in decentralized systems such as a distributed ledger system made up of the distributed nodes. The distributed nodes may use the zero-knowledge proof to verify transactions (e.g., adding new policies to the ledger) without oversight of a central authority. For example, a distributed node may verify that the trusted issuer 170 (and/or other component of the system) is authorized to write policies, public keys, and/or other data to the distributed ledger system. An example of a non-interactive zero-knowledge protocol is a zero-knowledge Succinct Non-interactive Argument of Knowledge (zk-SNARK). A zero-knowledge proof protocol (e.g., such as zk-SNARK, zk-STARK, and/or others) may be transparent and/or universal. A transparent protocol is one that does not require a trusted setup but may rely on public randomness. A universal protocol is one that does not require a separate trusted setup for each arithmetic circuit, where an arithmetic circuit represents a directed acyclic graph involving the addition and/or multiplication of numbers; for example, to compute a polynomial.

In some implementations, the trusted issuer 170 (or other entity) may provide a trusted setup for the zero-knowledge proof. In some implementations, a different component (e.g., independent of the trusted issuer 170, client device 110, and the resource system(s) 120) may provide the trusted setup. For example, the trusted issuer 170 may send prover setup to the client device 110 and verifier setup to the resource system(s) 120. The prover setup and the verifier setup may be collectively referred to as a “trusted setup”. In some implementations, the prover setup may be data representing, for example, a prover key and/or a structured reference string. In some implementations, the verifier setup may be data representing, for example, a verifier key and/or a structured reference string. The trusted setup may facilitate the zero-knowledge proof between the client device 110 (e.g., the prover) and the resource system(s) 120 (e.g., the verifier). A zero-knowledge proof may be used by the user 5 to establish to the resource system(s) 120 that the user 5 possesses credentials that correspond to policies for access of the resource system(s) 120. By using the zero-knowledge proof, the user 5 may keep their exact identity hidden from the resource system(s) 120 and/or any observer(s) of the data that passes between the client device 110 and the resource system(s) 120. An observer may, however, be permitted to witness the operation(s) performed and/or the results thereof, and see that the resource system(s) 120 authorized the operation(s) based on a policy that may also be visible to the observer. The resource system(s) 120 may therefore balance the interests of privacy for the user 5 and trust on the part of the observer.

In some implementations, the trusted issuer 170 may provide verified credentials (VCs) corresponding to the user 5 to the client device 110. The wallet 112 may include a secure (e.g., encrypted) data storage component on and/or associated with the client device 110. The VCs may correspond to one or more attributes about (or assigned to) the user 5. For each attribute (“att”), the trusted issuer 170 may send to the client device 110:

$${σ}_{att} = {sign}_{pk ( IdP )} ( att ‖ {pk}_{Requestor} )$$

The user 5 may wish to prove a claim c about an attribute; for example, that the user 5 is over the age of 18, the user 5 is a member of organization ABC, the user 5 is authorized to read, modify, and/or write data to the resource system(s) 120, the user 5 has been granted Tier-2 access but not Tier-1 access, etc. with respect to permissions for use of the resource system(s) 120. As can be appreciated, a number of claims/attributes are possible. The user 5 may prove to the resource system(s) 120 that c (att) is true, that the trusted issuer 170 certifies that the user 5 has the attribute att, and that att was signed (e.g., that att was used to assert claim c).

The user 5 may fetch the prover setup from the trusted issuer 170. The prover setup may represent a prover key for the corresponding claim PK_{IdP,c} and a structured reference string SRS_{IdP}.

Using the prover setup, the wallet 112 may build the following proof:

$${P}_{att , Requestor , Idp} = Proof ( {σ}_{att} is valid and c ( att ) == true , {PK}_{IdP , c} , {SRS}_{IdP} )$$

Which verifies that:

$$verify ( {σ}_{att} , att ‖ {pk}_{Requestor} ) == true and c ( att ) == true )$$

The client device 110 may send the proof P_{att,Requestor,IdP} to the resource system(s) 120 and/or the verifier system 180. The resource system(s) 120 and/or the verifier system 180 may fetch the verifier setup from the trusted issuer 170. The verifier setup may represent a verifier key for the corresponding claim VK_{IdP,c} and a structured reference string SRS_{IdP}. The resource system(s) 120 and/or the verifier system 180 may then verify the proof P from the client device 110:

$$Verify ( {P}_{att , Requestor , IdP} , {VK}_{IdP , c} , {SRS}_{IdP} ) == valid$$

If the claim c accurately represents the VC(s), the proof P will establish that c(att) is true and/or that the trusted issuer 170 assigned att to the user 5. The resource system(s) 120 and/or the verifier system 180 may then permit access to the protected resource or service and create a delegated token.

The resource system(s) 120 may include one or more internal systems or subsystems with which the user 5 may interact upon successful registration and/or authentication. The resource system(s) 120 may execute on the same hardware components and/or may be distributed across multiple system components (e.g., such as the system component 700 illustrated in FIG. 6). The resource system(s) 120 may include a resource authenticator 130, one or more resource front ends 140, and one or more resource back ends 150. In some cases, all of the resource systems 120 may execute on the same hardware components. In some cases, division of the resource system(s) 120 between and/or distribution of the resource system(s) 120 among various hardware components may make the system 100 more secure by isolating functions and preventing data leakage. In some cases, different functions of the system 100 may be performed on different hardware components having different configurations depending on the demands of the particular functions (e.g., emphasizing memory speed/bandwidth, processor speed/bandwidth, neural network processing, storage capacity, etc.).

The resource authenticator 130 may include hardware (such as web servers) and/or software (e.g., code for presenting one or more webpages) configured to provide an interface through which the user 5 may sign up and/or log in to access the resource system(s) 120. For example, the resource authenticator 130 may present the user 5 with a login page and, following a successful sign up and login, present a code that the user 5 may scan/receive using the wallet 112 to initiate registration with the system 100.

The resource authenticator 130 may further include hardware and/or software configured to provide an interface for a user 5 to access the resource front end(s) 140 and/or resource back end(s) 150. Once the user 5 has registered with the system 100 and obtained verification of its ZKP from the verifier system 180, the user 5 may log in to the resource front end 140. The resource authenticator 130 may present another code to create a session with the wallet 112. Upon the user 5 approving the session, the resource authenticator 130 may request VCs. The user 5 may select a key for signing a verifiable proof (VP), and the wallet 112 may generate the VP and return it to the resource authenticator 130. The resource authenticator 130 may host a verifier API 144 for receiving the VP. The resource authenticator 130 may verify the proof itself and/or delegate verification to another component of the system 100 (e.g., a verifier system 180) or another system altogether. For example, the component or component(s) that verify the proof may do so without obtaining any secret information about the user 5, the VCs, or the system 100; thus, verification may be performed by a miner. Upon verifying (or obtaining verification of) the proof, the resource authenticator 130 may authorize the requested access, store or update a session ID corresponding to the request, and create a delegated authentication token. The resource authenticator 130 may then forward the authentication token to the resource front end 140 and/or resource back end 150. The user 5 may then interact with the resource front end 140 to access data and/or application hosted by the resource back end 150. for example, the user may send a request for data to the resource front end 140, which may retrieve the requested data from the resource back end 150, and present it to the user 5 via the client device 110 as a visualization.

In some implementations, the resource authenticator 130 may authenticate access to different resource front ends 140 and/or resource back ends 150. The resource authenticator 130 may allow the user 5 to authenticate to one resource at a time (e.g., corresponding to a single resource front end 140 and resource back end 150) or multiple resources at a time (e.g., corresponding to multiple resource front ends 140 and resource back ends 150). Whether the resource authenticator 130 authenticates the user for multiple resources may depend on resource policies, the type of authentication used for particular resources, and/or specific permissions granted to the user.

The resource back end 150 may include hardware (e.g., the system component(s) 700) and/or software configured to receive, store, process, and/or return data in response to requests from the resource front end 140 and/or an authenticated client device 110 directly. The resource back end 150 may represent any data storage and/or computing system for the system 100 can provide privacy-preserving (e.g., verified but anonymous) authentication for access. The resource back end 150 may be, for example and without limitation, a data provider system, a secure data owner, a secure data repository, a model provider system, a secure data/model processing system, a content hosting platform, etc.

The system 100 may include one or more registries 160. A registry 160 may include software and/or hardware configured to maintain a catalog of identity documents and/or cryptographic keys (e.g., corresponding to trusted issuers 170). A registry 160 may also maintain a record of the status of VCs, such as whether a VCs has been revoked prior to its expiration. For example, a VC may correspond to an organization or a user. When issued, a VC may have a predetermined expiration date of one month, six months, one year from issuance. In some cases, credentials may be compromised and need to be replaced. In other cases, however, a user or organization may have their access to the resource suspended or terminated for various reason including, for example, a breach of terms of service, nonpayment of fees, etc. If certain VCs need to be revoked for any reason, the trusted issuer 170 and/or the resource system(s) 120 may make a record of the revocation in the registry 160. If a user later attempts to access the resource using those VCs, the verifier system 180 may check the registry 160, determine that the VCs are no longer valid, and inform the resource system(s) 120 so that access can be blocked. In some cases, the same registry 160 may maintain both the identity documents, keys, and/or VC status records; in other cases, different registries 160 may store the different types of information.

In some implementations, one or more of the registries 160 may include a distributed ledger such as a blockchain. A distributed ledger may represent a shared, replicated, and synchronized data store. A distributed ledger system may include a plurality of distributed nodes that maintain copies of data. A node may include hardware and/or software configured to receive data to add to the distributed ledger an implement a consensus algorithm to ensure the data stored by the distributed nodes is reliably replicated among them. The consensus algorithm is used to determine the correct updated ledger to represent the addition of the new data to the distributed ledger (e.g., in this case, the registry(ies) 160). Distributed nodes may form a peer-to-peer network (e.g., within and/or across the computer network 199) to propagate updates once the correct updated ledger is determined. Each distributed node will then update itself accordingly. The result is a tamper resistant record of the received data replicated across multiple nodes and without a single point of failure.

The distributed ledger may be a linear data structure (e.g., a chain such as blockchain) or a more complex structure like a directed acyclic graph. A directed acyclic graph in the context of a distributed ledger may be made up of blocks of data and edges indicating adjacency of data blocks added to the distributed ledger. Each edge is directed, indicating a direction from an existing data block to a new data added to the existing data block. The structure is acyclic in that it contains no paths by which a data block can be crossed twice by traversing any sequence of edges according to their direction (e.g., no edges are directed “backwards” in time). A data block may, however, have multiple edges directed to it and/or away from it.

The consensus algorithm may be a proof-of-work algorithm or a proof-of-stake algorithm. A proof-of-work algorithm is a form of cryptographic proof a party can use to prove to others that it has performed a certain about of computational work. The proof is asymmetric in that a verifier may confirm the proof with minimal computational effort. An example of proof-of-work in the context of distributed ledgers is “mining” for cryptocurrency, where mining refers to the incentive structure used to encourage nodes to expend computational effort to add data blocks to the distributed ledger. In contrast, proof-of-stake protocols only allow nodes owning some quantity of data blocks (e.g., blockchain tokens) to validate and add new data blocks. Proof-of-stake protocols prevent attackers from hijacking validation by requiring an attacker to acquire a large proportion of data blocks. Proof-of-stake protocols include, for example, committee-based proof of stake, delegated proof of stake, liquid proof of stake, etc.

Distributed ledgers may be permissioned or permissionless. A permissioned distributed ledger may refer to a private system having a central authority for authorizing nodes to add data blocks. In some cases, a consortium may agree to operate a distributed ledger jointly among the participating organizations while excluding others. A permissionless distributed ledger may refer to an open or public network for which no access control is used. Any party may add to the distributed ledger, provided they satisfy the consensus algorithm (e.g., proof of work). An example of a permissionless distributed ledger is bitcoin and other cryptocurrencies that require new entries to include a proof of work.

In some implementations, the distributed nodes may be open (e.g., viewable by the public) to allow an observer to see which VCs correspond to which trusted issuers and which VCs are valid, revoked, or expired. In some implementations, the distributed nodes may be private, prevented unauthorized observers from seeing the content of the registry (ies).

The trusted issuer 170 may be a system or systems that act as a certificate authority. A certificate authority (or certification authority) may be an entity that stores, signs and/or issues digital certificates. A digital certificate may certify ownership of a public cryptographic key by a named subject of the certificate. The digital certificate may allow relying parties to rely upon the signature and/or on an assertion made about the private cryptographic key that corresponds to the certified public key. Thus, the trusted issuer 170 may act as a third party that is trusted by both the subject (e.g., the user 5) of the certificate and by the party relying on the certificate (e.g., the resource system(s) 120). In various implementations, the trusted issuer 170 may include a DID registry, a government agency, a financial institution, etc.

The trusted issuer 170 may generate trusted issuer identity documents (e.g., issuer DID documents). The trusted issuer identity document may specify the trusted issuer's identity (e.g., DID), public cryptographic key(s), and/or information about the types of credentials the trusted issuer is authorized to issue. The trusted issuer 170 may send the trusted issuer identity documents to the registry 160 for storage and later retrieval by the user 5 (e.g., via the wallet 112) and/or the resource system(s) 120.

During the registration phase, a user 5 may obtain VCs by logging into the credentials website 190, obtaining the trusted issuer ID, using the trusted issuer ID to obtain the trusted issuer ID document from the registry 160, and use the information in the trusted issuer ID document to request VCs via the VC API 152 hosted by the trusted issuer 170. The trusted issuer 170 may use the private key of the trusted issuer 170 to generate VCs by signing a hash of the user's secret information (e.g., a password, attributes, sensitive data, etc.). The trusted issuer 170 may send the VCs to the user's wallet 112.

The verifier system 180 may include hardware and/or software configured to verify ZKPs and/or verify the current validity of VCs during the authentication phase. In some implementations, the verifier system 180 may itself verify the ZKP and/or delegate verification to another component of the system 100 or another system altogether. For example, the component or component(s) that verify the proof may do so without obtaining any secret information about the user 5, the VCs, or the system 100; thus, verification may be performed by a cryptographic miner. The verification receipt may have an expiration time (e.g., one day, one week, one month, etc.). During that time, the user 5 may use the verification receipt to request authentication by the system 100. When the user 5 logs into the resource system(s) 120, the resource system(s) 120 may request the user's VCs, which the user 5 may return in the form of a verifiable presentation (VP) to the resource system(s) 120 (e.g., via the verifier API 144). The resource system(s) 120 may call upon the verifier system 180 to verify the VP. Prior to verifying the VP, the verifier system 180 may check the current validity of the VP using registry 160. If the VCs are still valid, the verifier system 180 may return a verification result to the resource system(s) 120, which in turn may authorize the requested access to the resource.

FIG. 3 is a signal flow diagram illustrating example operations of registering with the system 100, according to embodiments of the present disclosure. During the registration phase, the user 5 may obtain a verified digital credential (e.g., VCs) from a trusted issuer. The trusted issuer may be a government agency, financial institution, and/or any other authorized entity capable of issuing and managing digital identities and credentials. The trusted issuer 170 may represent the component(s)/system(s) performing the electronic operations of the trusted issuer.

Prior to a user 5 requesting access to a resource, the trusted issuer 170 may send (302) its identity document to a registry 160. The trusted issuer identity document may be, for example, a DID document. The identity document may include the trusted issuer's identifier (e.g., a DID) and public keys corresponding to private keys held by the trusted issuer 170 that may be used to digitally sign VCs. An administrator of the trusted issuer may create the trusted issuer identity document and deposit it with the registry 160. The registry 160 may store identity documents from multiple trusted issuers 170. The registry 160 may store the identity document securely (e.g., in a decentralized and/or distributed ledger) such that a party may resolve the trusted issuer's identifier to retrieve the trusted issuer's identity document from the registry 160, and trust that the document is accurate and has not been modified.

The user 5 may request (304) access to the resource by, for example, using the second client device 110b to log in to the credentials website 190. The user 5 may register with the credentials website 190 (e.g., if visiting for the first time) or log in to the credentials website 190 if the user 5 already has a username and password (and/or passkey, using multi-factor authentication (MFA), etc.). The login may indicate to the credentials website 190 that the user 5 is requesting access to a resource hosted by the resource system(s) 120. In some cases, the user 5 may request the access following successful login. Upon receiving the request, the credentials website 190 may present a code via the second client device 110b.

The user 5 may use the first client device 110a to scan (306) the code (e.g., by scanning a QR code, recognizing a string of characters, receiving a wireless signal, etc.). The wallet 112 may obtain (308), from the code and/or using the code, information regarding the trusted issuer 170 and how to request verified credentials from it. For example, the code may contain a link (e.g., a uniform resource locator (URL)) to a website where the wallet 112 may obtain an identifier of the trusted issuer 170 and a key for accessing a VC API 152 hosted by the trusted issuer 170. In some cases, the code itself may convey the identifier and key. The first client device 110a (e.g., the wallet 112) may process the captured image data to obtain the trusted issuer identifier and the VC API key.

The wallet 112 may resolve the trusted issuer's identity document using the trusted issuer identifier. The wallet 112 may (310) a request containing the trusted issuer identifier to the registry 160. The registry 160 may return (312) the trusted issuer identity document corresponding to the trusted issuer identifier. The trusted issuer identity document may define an endpoint for the VC API 152, include the trusted issuer's public keys, and in some cases specify an expected renewal frequency for the credentials (e.g., every one month, three months, six months, twelve months, etc.). The wallet 112 may register (314) the resource for use in requesting VCs and logging in to the resource.

The user 5 may register with the trusted issuer's VC issuance and renewal system (e.g., the trusted issuer 170) by providing requested information and requesting a new VC. In some implementations, the wallet 112 may generate (316) a key pair. Using the endpoint, the wallet 112 may send (318) a request for VCs to the VC API 152 (e.g., to the endpoint specified in the trusted issuer identity document). In some implementations, the request may include a secret (e.g., a password and/or other sensitive data that the wallet 112 may use to establish identity and entitlement to the VCs). If the request includes a secret and the public key generated by the wallet, the trusted issued 170 (or other system/component hosting the VC API 152) may hash (320) the secret and sign the public key using the trusted issuer's private key. The trusted issuer 170 may return (322) the VCs (e.g., containing the hashed secret) to the wallet 112. The wallet 112 may store the VCs for later use. The wallet 112 may then present (324) the user 5 with an indication to the user 5 that the VCs are registered.

FIG. 4 is a conceptual diagram of an example environment 400 in which the system authenticates a request to access the resource system(s) 120, according to embodiments of the present disclosure. During the authentication phase, the user may request access to a protected resource and/or service by proving possession of the VC(s) obtained during the registration phase (e.g., described above with reference to FIGS. 2 and 3) without revealing the actual credential or any other sensitive information. The environment 400 may be the same as or similar to the environment 200 described with respect to the registration phase; for example, during the authentication phase, the operations may include interactions with the same or different registries 160 and/or the same or different resource systems 120.

During the authentication phase, the registry (ies) 160 may verify the current validity of a VC (e.g., in case the VC has been revoked prior to its predetermined expiration). Thus, in some implementations, the system 100 may use the same registry 160 for storing trusted issuer identity documents and VC validity/revocation lists. In other implementations, the system 100 may include separate registries for each purpose. In either case, a registry may be decentralized and/or distributed; for example, in the case of a decentralized ledger or blockchain.

During the authentication phase, the user 5 may attempt to log into the resource system(s) 120 to initiate or continue a session with the protected resource. The resource system(s) 120 may include a resource authenticator 130 configured to authenticate the user's 5 request to access the resource system(s) 120. In some implementations, the resource authenticator 130 may be separate from the resource front ends 140 and resource back ends 150 (e.g., under the control of a separate entity and/or administrator). In some implementations, the resource authenticator 130 may authenticate request to access multiple resource front ends 140 and resource back ends 150 as described previously. In some implementations, the resource systems 120 may reside on shared hardware (e.g., system component(s) 700) while in other implementations, individual resource systems 120 may reside on separate hardware. Upon successful authentication, the resource authenticator 130 may create a delegated authentication token and send it to the resource front end 140 and/or resource back end 150 to indicate that subsequent requests corresponding to the token may be granted.

When the user 5 logs in to the resource authenticator 130, the resource authenticator 130 may present the code, which the user 5 may receive using the wallet 112. The wallet 112 may prompt the user to approve the generation of a verifiable presentation (VP) and select one or more VCs to use. The wallet 112 may generate the VP and send it to the resource authenticator 130 (e.g., via the verifier API 144), which may leverage the verifier system 180 to verify the current validity of the VCs. The VP may demonstrate that the user 5 possesses the relevant VCs, without sharing the VCs themselves. In various implementations, the wallet 112 may generate the VP using, for example, classic cryptographic techniques, post-quantum cryptographic techniques, and/or a ZKP. For example, the VP may include the signed secret obtained from the trusted issuer 170 (e.g., a salted hash of their password or other secret information). In another example, the VP may include a ZKP of possession of the VCs. The wallet 112 may generate the ZKP itself, or provide signed, hashed VCs to a separate system (e.g., via prover API), which will generate the ZKP and return it to the wallet 112. In yet another example, the wallet 112 may implement one or more quantum-resistant public key algorithms to create a digital signature that is secure against cryptanalytic attacks by actors using quantum computers. This may add security to the use of the private key against future decryption using the public key and/or data that has been digitally signed using the public key.

The wallet 112 may send the VP to the resource authenticator (e.g., via the verifier API 144). In some implementations, the resource authenticator 130 may send the VP to the verifier system 180 for verification. The verifier system 180 may verify the VP and return a verification result. In some implementations, the VP may include an anonymous but public identifier of the user (e.g., the user's DID and/or an organization identifier (OID)). The verifier system 180 may check the validity of the anonymous identifier in the registry (ies) 160.

Once the system 100 has verified the VP, the resource authenticator 130 may authorize access to the requested resource or service. The resource authenticator 130 may create a session identifier and generate a delegated authentication token. The delegated token may persist for some time (e.g., a few days to a few weeks) to allow the user 5 to continue an in-progress session without having to repeat the authentication process. The resource authenticator 130 may send the token to the resource front end(s) 140 and/or resource back end(s) 150.

FIGS. 5A and 5B are signal flow diagrams illustrating example operations of authenticating a request to access the resource system(s) 120, according to embodiments of the present disclosure. During the authentication phase, the user 5 may attempt to log in to the resource authenticator 130 to access the protected resource and use a VP to prove the possession of valid VCs without divulging the credentials themselves or any other sensitive information such as the user's individual identity, password, etc. Upon successful verification of the user's VP, the resource authenticator 130 may provide the user 5 with access to the protected resource hosted by the resource back end 150. The resource authenticator 130 may create a token that allows the user to continue the session at a later time without having to repeat the authentication process.

The user 5 may send (510) their login information to the resource authenticator 130 (e.g., using a second client device 110b as shown in FIG. 1). The resource authenticator 130 may verify the login information and present a code (e.g., a QR code, string of characters, NFC transmission, etc.). The user 5 may scan/read (512) the code using the digital wallet application 112. The code may include a URL or other information that causes the wallet 112 to send, to the resource authenticator 130, a request to initiate a secure wallet-connect session. The resource authenticator 130 may initiate (514) the wallet-connect session with the wallet 112. The wallet 112 may prompt the user 5 to approve the wallet-connect session. The user 5 may approve (516) wallet-connect session by, for example, tapping or swiping an approval button presented on a touchscreen of the client device (e.g., the first client device 110a shown in FIG. 1). Once the user 5 approves the wallet-connect session, the resource authenticator 130 may send (518) a request for the user's VCs. The request may represent a challenge to prove the possession of the VCs. The challenge may be satisfied using VP. The wallet 112 may generate the VP using, for example, classic cryptographic techniques, post-quantum cryptographic techniques, and/or a ZKP.

The user 5 may select (520) a key for signing the VCs and approve (522) using the VCs to generate the VP to be sent to the resource authenticator 130. The wallet 112 may use the VCs obtained during the registration phase to generate (524) a VP of possession of those VCs. The wallet 112 may generate the VP using the VC(s) and, in some cases, other inputs such as a program specifying attributes to be revealed, a desired time range for access, an intended audience of the proof (e.g., a specific resource system 120), etc. In some implementations, the wallet 112 may leverage a separate device or system (e.g., one having more computational resources than the client device 110) to generate the VP (e.g., a ZKP). For example, the component or component(s) that verify the proof may do so without obtaining any secret information about the user 5, the VCs, or the system 100; thus, ZKP generation may be performed by a cryptographic miner unaffiliated with other entities of the system 100. The ZKP may have an expiration time (e.g., one day, one week, one month, etc.). The expiration may be the same or different from the expiration of the underlying VC(s). Prior to expiration of the VCs, and/or ZKP, the user 5 may use the ZKP and/or VCs to generate (526) a VP for requested authentication by the resource authenticator 130. In some implementations, the wallet 112 may use the key(s) obtained during the registration phase to sign the VP. In some cases, the wallet 112 may generate an additional key pair, and sign the VP using the private key. The public key may be used as (or used to generate) an anonymous identifier (e.g., a DID) for the user.

Proceeding to FIG. 5B, the wallet 112 may send (528) the VP to the resource authenticator 130 (e.g., via the verifier API 144) for verification. The resource authenticator 130 may verify the VP itself or send (530) the VP to the verifier system 180 for verification. The verifier system 180 may verify the VP against the trusted issuer's public keys (e.g., obtained from the trusted issuer's identity document). The verifier system 180 may verify that the VP proves possession of the VC(s) required to access the protected resource and verifies that the VC is currently valid (e.g., has not been expired or revoked with respect to the user's anonymous identifier). For example, the verifier system 180 may use the registry (ies) 160 to verify (532) that the VCs, the user's anonymous identifier, and/or the user's organization identifier are currently listed as valid and/or not currently listed as revoked. The verifier system 180 may verify that the VP satisfies attributes and/or policies for the requested resource or service. If the VP is valid, the verifier system 180 may return (534) the verification result to the resource authenticator 130.

Upon receiving the verification result from the verifier system 180, the resource authenticator 130 may authorize (536) access to the requested resource and either create a new session identifier or updated a stored session identifier for a session already in progress. The resource authenticator 130 may create (538) a delegated token for the session. The resource authenticator 130 may send (540) the token to the resource front end 140 and/or the resource back end 150. The token may allow the user 5 to access the protected resource. In some implementations, the token may include or be accompanied by the user's anonymous identifier. This may allow the user 5 to return to the session later without repeating the authentication process or providing individually unique information to the resource system(s) 120. Once the session has been initiated or resumed, the user 5 may interact with the resource front end 140 to access to the protected resource or service. For example, the user may send (542) a request for data to the resource front end 140. The resource front end 140 may retrieve (544) the requested data from the resource back end 150. The resource front end 140 may create a visualization of the requested data and send (546) the visualization to the user 5 (e.g., to the second client device 110b) for display. The resource front end 140 may visualize data associated with the user's VC(s) and/or identifier, such as personal information, credentials, or other relevant attributes. The resource front end 140 may provide a visualization of data that corresponds to the user's consent and/or policies defined by the trusted issuer and/or the resource system(s) 120.

Throughout the authentication process, the user 5 need not share sensitive information such as passwords or credential details in plaintext. The VP and delegated token may allow the user 5 to cryptographically prove possession of a valid, digitally signed credential and knowledge of the associated secret information without disclosing the credentials/information themselves.

The system 100 may thus provide a secure and privacy-preserving method for user authentication and authorization, leveraging the benefits of decentralized identity technology and zero-knowledge proofs. Users can selectively disclose VCs to access protected resources and/or services without revealing sensitive personal information, while service providers can be assured of the user's' authenticity and attributes without handling or storing passwords or other sensitive data.

FIG. 6 is a block diagram illustrating an example user device 600 and system component 700 communicating over a computer network 199, according to embodiments of the present disclosure. In some implementations, the client device 110 may be a user device 600 as a shown in FIG. 6. In some implementations, the client device 110 may be a system component 700 as shown in FIG. 6 and/or a virtual machine executing on one or more system components 700. One or more system components 700 may make up one or more of the components described in the example environments 200 and/or 400. For example, the resource system(s) 120, the registry (ies) 160, the trusted issuer 170, and/or the verifier system 180 may be made up of (and/or execute on) one or more system components 700.

While the user device 600 may operate locally to a user 5 (e.g., within a same environment so the device may receive inputs and playback outputs for the requestor) the system component(s) 700 may be located remotely from the user device 600 as its operations may not require proximity to the requestor. The system component(s) may be located in an entirely different location from the user device 600 (for example, as part of a cloud computing system or the like) or may be located in a same environment as the user device 600 but physically separated therefrom (for example a home server or similar device that resides in a requestors home or office but perhaps in a closet, basement, attic, or the like). In some implementations, the system component(s) 700 may also be a version of a user device 600 that includes different (e.g., more) processing capabilities than other user device(s) 600 in a home/office. One benefit to the system component(s) 700 being in a requestor's home/office is that data used to process a command/return a response may be kept within the requestor's home/office, thus reducing potential privacy concerns.

The user device 600 may include one or more controllers/processors 604, which may each include a central processing unit (CPU) for processing data and computer-readable instructions, and a memory 606 for storing data and instructions of the respective device. The memories 606 may individually include volatile random-access memory (RAM), non-volatile read only memory (ROM), non-volatile magnetoresistive memory (MRAM), and/or other types of memory. User device 600 may also include a data storage component 608 for storing data and controller/processor-executable instructions. Each data storage component 608 may individually include one or more non-volatile storage types such as magnetic storage, optical storage, solid-state storage, etc. User device 600 may also be connected to removable or external non-volatile memory and/or storage (such as a removable memory card, memory key drive, networked storage, etc.) through respective input/output device interfaces 602.

Computer instructions for operating user device 600 and its various components may be executed by the respective device's controller(s)/processor(s) 604, using the memory 606 as temporary “working” storage at runtime. A device's computer instructions may be stored in a non-transitory manner in non-volatile memory 606, data storage component 608, or an external device(s). Alternatively, some or all of the executable instructions may be embedded in hardware or firmware on the respective device in addition to or instead of software.

User device 600 includes input/output device interfaces 602. A variety of components may be connected through the input/output device interfaces 602, as will be discussed further below. Additionally, user device 600 may include an address/data bus 610 for conveying data among components of the respective device. Each component within a user device 600 may also be directly connected to other components in addition to (or instead of) being connected to other components across the bus 610.

The user device 600 may include input/output device interfaces 602 that connect to a variety of components such as an audio output component such as a speaker 612, a wired headset or a wireless headset (not illustrated), or other component capable of outputting audio. The user device 600 may also include an audio capture component. The audio capture component may be, for example, a microphone 620 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 600 may additionally include a display 616 for displaying content. The user device 600 may further include a camera 618.

Via antenna(s) 622, the input/output device interfaces 602 may connect to one or more computer networks 199 via a wireless local area network (WLAN) (such as Wi-Fi) radio, Bluetooth, and/or wireless network radio, such as a radio capable of communication with a wireless communication network such as a Long-Term Evolution (LTE) network, WiMAX network, 3G network, 4G network, 5G network, etc. A wired connection such as Ethernet may also be supported. Through the network(s) 199, the system may be distributed across a networked environment. The I/O device interface 602 may also include communication components that allow data to be exchanged between devices such as different physical servers in a collection of servers or other components.

The system component 700 may include one or more physical devices and/or one or more virtual devices, such as virtual systems that run in a cloud server or similar environment. The system component 700 may include one or more input/output device interfaces 702 and controllers/processors 704. The system component 700 may further include a memory 706 and storage 708. A bus 710 may allow the input/output device interfaces 702, controllers/processors 704, memory 706, and storage 708 to communicate with each other; the components may instead or in addition be directly connected to each other or be connected via a different bus.

A variety of components may be connected through the input/output device interfaces 702. For example, the input/output device interfaces 702 may be used to connect to the computer network 199. Further components include keyboards, mice, displays, touchscreens, microphones, speakers, and any other type of user input/output device. The components may further include USB drives, removable hard drives, or any other type of removable storage.

The controllers/processors 704 may processes data and computer-readable instructions and may include a general-purpose central-processing unit, a specific-purpose processor such as a graphics processor, a digital-signal processor, an application-specific integrated circuit, a microcontroller, or any other type of controller or processor. The memory 706 may include volatile random-access memory (RAM), non-volatile read only memory (ROM), non-volatile magnetoresistive (MRAM), and/or other types of memory. The memory 706 may be used for storing data and controller/processor-executable instructions on one or more non-volatile storage types, such as magnetic storage, optical storage, solid-state storage, etc.

Computer instructions for operating the system component 700 and its various components may be executed by the controller(s)/processor(s) 704 using the memory 706 as temporary “working” storage at runtime. The computer instructions may be stored in a non-transitory manner in the memory 706, storage 708, and/or an external device(s). Alternatively, some or all of the executable instructions may be embedded in hardware or firmware on the respective device in addition to or instead of software.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and data processing should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of one or more of the modules and engines may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain 25 embodiments require at least one of X, at least one of Y, or at least one of Z to each be present. As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
obtaining, by a user device, first data presented by a computing device used to request access to a resource system;
determining, using the first data, a first identifier corresponding to a trusted issuer system and a first key for accessing the trusted issuer system;
retrieving, from a first registry system using the first identifier, second data representing a first endpoint for accessing the trusted issuer system;
sending, from the user device to the first endpoint, the first key and a first request for verified credentials;
receiving, from the trusted issuer system in response to the first request, verified credential data; and
presenting a first indication that the user device has obtained the verified credentials for accessing the resource system.

2. The computer-implemented method of claim 1, further comprising:
capturing image data using a camera of the user device, the image data representing an image presented by the computing device; and
determining, using a digital wallet application of the user device, a uniform resource locator (URL) represented by the image data, wherein the digital wallet application obtains the first data using the URL.

3. The computer-implemented method of claim 2, wherein the image data represents a quick response (QR) code.

4. The computer-implemented method of claim 1, further comprising:
prior to obtaining the first data, receiving, by the computing device, a second request to access the resource system; and
in response to the second request, sending the first data to the computing device.

5. The computer-implemented method of claim 1, further comprising:
determining, using the second data, a first public key corresponding to a first private key, the first public key and the first private key corresponding to the trusted issuer system;
determining, using a digital wallet application of the user device, a cryptographic key pair including a second public key and a second private key; and
sending the second public key to the first endpoint, wherein the verified credential data includes the second public key signed using the first private key.

6. The computer-implemented method of claim 5, further comprising:
generating, using a digital wallet application of the user device, third data representing a verifiable proof of possession of the verified credential data; and
using the third data to obtain access to the resource system.

7. A computer-implemented method comprising:
obtaining, by a user device, first data presented by a computing device used to request access to a first resource system;
determining, using the first data, a first identifier corresponding to the first resource system;
sending, using the first identifier, a first request for authentication to access the first resource system;
receiving a second request to demonstrate possession of verified credentials issued by a trusted issuer system;
sending, in response to the second request, second data representing a verifiable proof of possession of the verified credentials; and
receiving, by the user device, a first indication that the verifiable proof has been verified, the first resource system presenting second data to the computing device in response to the verifiable proof being verified.

8. The computer-implemented method of claim 7, further comprising:
capturing image data using a camera of the user device, the image data representing an image presented by the computing device; and
determining, using a digital wallet application of the user device, a uniform resource locator (URL) represented by the image data, wherein the digital wallet application obtains the first data using the URL.

9. The computer-implemented method of claim 7, further comprising:
generating, using a digital wallet application of the user device, third data representing a zero-knowledge proof of possession of the verified credentials; and
determining the second data using the third data.

10. The computer-implemented method of claim 7, further comprising:
determining third data representing a hash of verified credential data representing the verified credentials;
determining fourth data by applying a digital signature to the third data;
sending the fourth data to a system component, the system component processing the fourth data to generate a zero-knowledge proof (ZKP) of the verified credentials;
receiving, by the user device, fifth data representing the ZKP of the verified credentials; and
determining the second data using the fifth data.

11. The computer-implemented method of claim 7, further comprising:
in response to the verifiable proof being verified, receiving, by the user device, a second indication that access has been granted to the first resource system and a second resource system different from the first resource system.

12. The computer-implemented method of claim 7, further comprising:
prior to obtaining the first data, obtaining, by a digital wallet application of the user device, a first identifier corresponding to the trusted issuer system;
sending, to a system component, a third request for information regarding the trusted issuer system;
receiving, in response to the third request, third data representing a first endpoint for accessing the trusted issuer system;
sending, to the trusted issuer system, a fourth request for verified credential data representing the verified credentials; and
receiving, by the digital wallet application in response to the fourth request, the verified credential data.

13. A computer-implemented method comprising:
receiving, from a computing device, a first request to access a first resource system;
sending, to the computing device, first data representing a first identifier corresponding to the first resource system;
receiving, from a user device, second data representing the first identifier and a second request for authentication to access the first resource system;
sending, to the user device, a third request to demonstrate possession of verified credentials issued by a trusted issuer system;
receiving, in response to the third request, third data representing a verifiable proof of possession of the verified credentials;
determining that the third data demonstrates possession of the verified credentials; and
in response to determining that the third data demonstrates possession of the verified credentials, granting the computing device access to the first resource system.

14. The computer-implemented method of claim 13, further comprising:
in response to determining that the third data demonstrates possession of the verified credentials, generating fourth data representing an authenticated token indicating the grant of access to the first resource system; and
sending the fourth data to at least a first system component corresponding to the first resource system.

15. The computer-implemented method of claim 14, further comprising:
determining that the third data indicates a first identifier corresponding to at least one of the user device or the computing device, wherein the fourth data is generated to indicate the first identifier in response to determining that the third data indicates the first identifier;
receiving a fourth request for authentication to access the first resource system;
determining that the fourth request corresponds to the first identifier; and
in response to determining that the fourth request corresponds to the first identifier, granting the computing device access to the first resource system based at least on the fourth data.

16. The computer-implemented method of claim 14, further comprising:
in response to determining that the third data demonstrates possession of the verified credentials, sending the fourth data to at least a second system component corresponding to a second resource system different from the first resource system.

17. The computer-implemented method of claim 13, further comprising:
prior to receiving the first request, receiving, from the user device, a fourth request for information regarding the trusted issuer system; and
sending, in response to the fourth request, fourth data representing a first identifier corresponding to a trusted issuer system and a first key for obtaining the verified credentials from the trusted issuer system, wherein the user device obtaining verified credential data representing the verified credentials using the first identifier and the first key.

18. The computer-implemented method of claim 13, further comprising:
determining that the third data represents a zero-knowledge proof (ZKP) of possession of the verified credentials;
sending the third data to a system component for verification of the ZKP; and
receiving, in response to the third data, a first indication that the ZKP demonstrates possession of the verified credentials.

19. The computer-implemented method of claim 13, further comprising:
determining that the third data represents a first identifier corresponding to at least one of the user device or the computing device;
sending, to a system component, fourth data representing the first identifier; and
receiving, in response to the fourth data, a first indication that the verified credentials corresponding to the first identifier are valid.

20. The computer-implemented method of claim 19, further comprising:
receiving a fourth request for authentication to access the first resource system;
determining a second identifier corresponding to the fourth request;
determining that second verified credentials corresponding to the second identifier are not valid; and
in response to determining that the second verified credentials corresponding to the second identifier are not valid, denying the fourth request.
